(19) United States
(12) Patent Application Publication
(10) Pub. No.: US 2012/0105443 A1
(43) Pub. Date: May 3, 2012

(54) System and Method for Generating A Three-Dimensional Patient Display

(76) Inventors: Jon Alan Klingborg, Atwater, CA (US); Cong Tan, Naperville, IL (US); Dake Feng, Beijing (CN)

(21) Appl. No.: 13/276,298

(22) Filed: Oct. 18, 2011

Related U.S. Application Data
(60) Provisional application No. 61/408,045, filed on Oct. 29, 2010.

(51) Int. Cl. G06T 15/00

(52) U.S. Cl. 345/419

(57) ABSTRACT

A system and method for generating a three-dimension view of patient information is disclosed. The present invention includes a user interface that is displayed on a client device, such as a tablet, laptop or personal computer. The user enters information about the patient into the program. The patient module generates a diagnosis in response to the received information.

### CROSS-REFERENCE TO RELATED APPLICATIONS

This application claims the benefit of provisional patent application Ser. No. 61/408,045, filed on Oct. 29, 2010 by Jon Klingborg.

### BACKGROUND OF THE INVENTION

1. Field of the Invention

The present invention relates to generating a three-dimensional display of a patient. In particular, the present invention relates to organizing a three-dimensional display of a patient based on organs and differentials.

2. Description of the Background Art

The following is a tabulation of some prior art that presently appears relevant:

### U.S. Pat. Nos.

| Patent Number | Kind Code | Issue Date | Patentee |
|---|---|---|---|
| 6,666,579 | B2 | Dec. 23, 2003 | Jensen |
| 6,697,067 | B1 | Feb. 24, 2004 | Callahan et al. |

### U.S. Patent Application Publications

| Publication Nr. | Kind Code | Publ. Date | Applicant |
|---|---|---|---|
| 20040002641 | A1 | Jan. 1, 2004 | Sjogren et al. |
| 20090116708 | A1 | May 7, 2009 | Kim |
| 20100114597 | A1 | May 6, 2010 | Shreiber et al. |

### Nonpatent Literature Documents

Richard Ward et al, Web publication, “Visual interface to human medical data: the virtual soldier hotbox.” http://www.csm.ornl.gov/˜71p/publis/Ward_pouchard_Hotbox.pdf (last accessed Sep. 30, 2011).

Compared to a hundred years ago, the medical community has access to an overwhelming surplus of information. Doctors are able to obtain practically infinite amounts of information to help diagnose problems. The problem, however, becomes how to organize that data. For years, doctors have been able to look up symptoms and identify potential diseases, but this can be extremely time consuming, especially when the symptoms are common.

One way that doctors organize data is to print out a piece of paper with diagrams of a body. When talking to a patient (or the patient's owner in the case of an animal), the doctor can circle the problematic area on the patient and make notes. This system, however, has many drawbacks. First, hand writing notes on a piece of paper is imprecise. Second, the paper only represents a two-dimensional model. Even if the paper includes a form at multiple angles, such as front and back, this ignores the fact that the inside of the patient contains layers of overlapping organs.

Several patent and patent applications have proposed imaging systems to obtain and display patient images. For example, U.S. Pat. No. 6,666,579 (2003) has disclosed ways to obtain and display patient images through X-ray image exposures. Patent application 2004/002641 has disclosed methods and systems to relate anatomical patient information between different medical machines. These inventions focus on how to create an accurate rendition of an object through image. Other inventions have proposed ways to create three-dimensional images. For example, U.S. Pat. No. 6,697,067 (2004) has disclosed methods and systems to create three dimensional image through a multi-frame object. Patent application 2009/0116708 has disclosed methods to display both the left and right sides of the patient simultaneously and symmetrically of a medical three dimensional image. These inventions focus on how to generate medical three-dimensional images accurately showing patient image. Yet another set of prior arts disclose ways to create effective medical reporting. For example, patent application 2010/0114597 has disclosed systems and methods to select a matching template using a medical imaging study and a medical record related to the patient to help the preparation of medical reports. Publication by Ward cited above has also disclosed ways to report prediction of outcomes from wounding based on X-ray CT and post wound imaging.

These prior arts have demonstrated progress on medical imaging and reporting. However, there is a need for a mechanism focusing to improve the quality of note taking and diagnosis of patients.

### SUMMARY OF THE INVENTION

The present invention overcomes the deficiencies and limitations of the prior art by providing a system and method for generating a three-dimensional model of a patient. The patient module contains a user interface for displaying a three-dimensional module and receiving information from the user. The three-dimensional model is rotatable and, in one embodiment, is divided according to different organs in the patent. A diagnosing engine receives information through the user interface and uses it to diagnose patient problems.

In addition to being a diagnostic tool, the patient module is also a recording tool for establishing a patient history and for tracking the progress of a patient's maladies. The user interface receives input from a user, for example, via a stylus that is recorded as part of the patient data. The notes can be made underneath the diagram of the patient and also be included as tags on specific parts of the body that are being discussed in the notes. This allows for precise identification of issues, such as exactly where an abrasion is located. In addition, the model allows for better tracking of a patient's progress because the doctor inputs exact measurements, characteristics and can even upload a picture of the patient and associate it with the three-dimensional display.

In one embodiment, the user interface generates a display of patient characteristics that are modifiable by a sliding scale. This allows for a more standardized process because patients are represented visually and there is no disagreement about whether the patient was thin or of normal size, whether the swelling was slight or extreme, etc. The sliding scale may be implemented by manipulating a body condition score (BCS) as detailed below.

The patient module includes a communication module for communicating with other programs via a network to streamline the process. For example, the doctor inputs information about a patient's high cholesterol and prepares a prescription for Lipitor. The communication module transmits the prescription to the patient's local pharmacy. At the end of the appointment, the communication module transmits the bill for the co-pay to the front desk so that the patient (or patient's owner) can pay for the appointment. In one embodiment, the patient module includes a form completion engine for generating the prescription forms, bills, etc. instead of merely sending the information to another software program to complete.

### BRIEF DESCRIPTION OF THE DRAWINGS

The invention is illustrated by way of example, and not by way of limitation in the figures of the accompanying drawings in which like reference numerals are used to refer to similar elements.

FIG. 1 is a high-level block diagram illustrating a functional view of a distributed patient module system according to one embodiment of the present invention.

FIG. 2 is one embodiment of a more detailed block diagram of the patient module.

FIG. 3 is a user interface of the general information screen for inputting patient information.

FIG. 4 is a user interface that displays the patient's weight in a graphical representation, as well as an interface for inputting the patient's temperature, pulse and respiration rate.

FIG. 5 is a user interface that displays the previous history of the patient, with the ability to access scanned blood work, radiographic images and other reports.

FIG. 6 is a user interface for inputting, in the case of an animal patient, the animal's sociability, emotional status, mentation, mucous membrane color, capillary refill time, and hydration.

FIG. 7 is a user interface for inputting an objective of different organs or organ-systems, and a Quick Summary of those organs or organ-systems that are abnormal.

FIG. 8 is a user interface of the eye that lists different eye structures and their characteristics. The eye is also represented graphically, with the ability for the user to note any pathology directly on the graphical image.

FIG. 9 is a user interface that includes a visual display of the different organs and indicates which organs have already been examined and which organs are abnormal

FIG. 10 is a user interface for inputting the assessment of a patient. It contains a summary of the problem list generated during the subjective and subjective components of the exam, as well as the differential diagnosis and tentative diagnosis

FIG. 11 is a user interface for developing a treatment or diagnostic plan for a patient.

FIG. 12 is a high-level block diagram illustrating process flow of the methods for generating three dimensional patient display.

### DETAILED DESCRIPTION OF THE PREFERRED EMBODIMENTS

A system and method for generating the three-dimensional model of a patient is described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention. For example, the present invention is described in one embodiment below with reference to user interfaces and particular hardware. However, the present invention applies to any type of computing device that can receive data and commands, and any peripheral devices providing services.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing machine suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

### System Overview

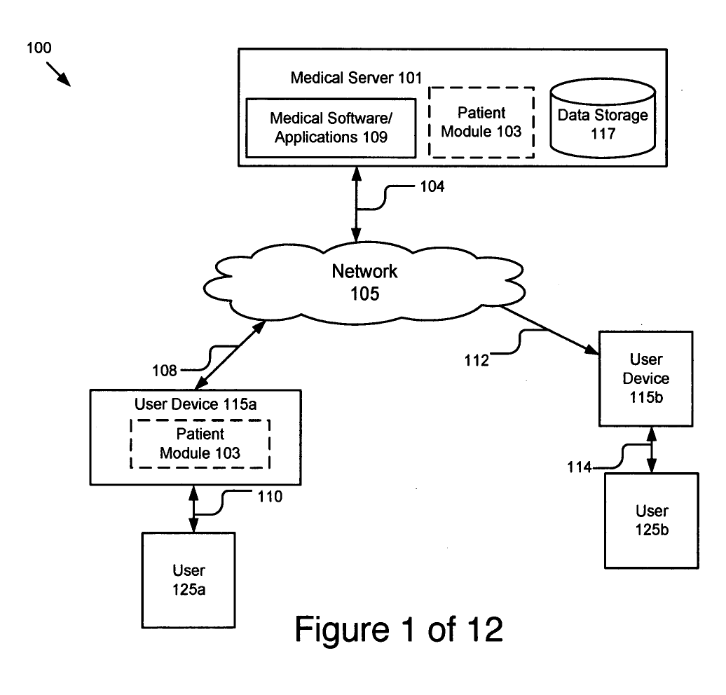

FIG. 1 illustrates a block diagram of a system 100 for generating a three-dimensional model according to one embodiment of the present invention. The illustrated invention of the system 100 includes user devices 115a, 115b that are accessed by users 125a, 125b and a medical server 101. In the illustrated embodiment, these entities are communicatively coupled via a network 105. The user devices 115a, 115b in FIG. 1 are used by way of example. While FIG. 1 illustrates two devices, the present invention applies to any system architecture having at least one and easily millions of users and user devices. Furthermore, while only one network 105 is coupled to the user devices, 115a, 115b and the medical server 101, in practice any number of networks 105 can be connected to the entities. In one embodiment, the patient module 103 is stored on the user device 115a.

In another embodiment, the patient module 103 is operable on a medical server 101 that also includes medical software/applications 109 and a data storage 117. The medical software/applications 109 communicate with the patient module 103 to provide comprehensive medical services. In one embodiment, the data storage 117 contains the patients' medical records.

In yet another embodiment, the patient module 103 is stored on the medical server 101 and is accessible through a website. In another embodiment, the patent module 103 is stored on a user device 115a and is accessible as a software application. The user device 115a includes any client computing device, such as a personal computer and a mobile device (a mobile phone, an iPad or any other device that accepts user input to complete electronic forms). Persons of ordinary skill in the art will recognize that the conferencing module 103 can be distributed or undistributed and can be stored in any combination on the devices and servers.

The network 105 is a conventional type, wired or wireless, and may have any number of configurations such as a star configuration, token ring configuration or other configurations known to those skilled in the art. Furthermore, the network 105 may comprise a local area network (LAN), a wide area network (WAN) (e.g., the Internet), and/or any other interconnected data path across which multiple devices may communicate. In yet another embodiment, the network 105 may be a peer-to-peer network. The network 105 may also be coupled to or includes portions of a telecommunications network for sending data in a variety of different communication protocols. In yet another embodiment, the network 105 includes Bluetooth communication networks or a cellular communications network for sending and receiving data such as via short messaging service (SMS), multimedia messaging service (MMS), hypertext transfer protocol (HTTP), direct data connection, WAP, email, etc. The various embodiments of the network are called communication networks.

In the illustrated embodiment, the user device 115a is coupled to the network 105 via signal line 108. The user 125a is communicatively coupled to the user device 115a via signal line 110. Similarly, the user device 115b is coupled to the network via signal line 112. The user 125b is communicatively coupled to the user device 115b via signal line 114. The medical software/application application 109 is communicatively coupled to the network 105 via signal line 104. The medical server 101 is communicatively coupled to the network 105 via signal line 104. The medical server 101 is also communicatively coupled to data storage 117 via signal line 104.

### Patient Module

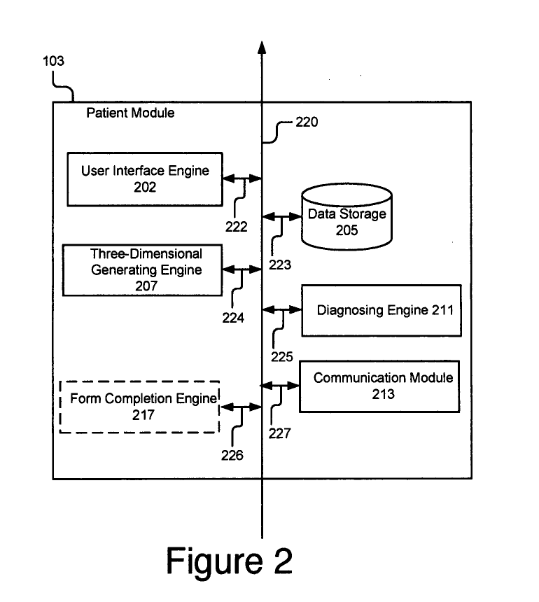

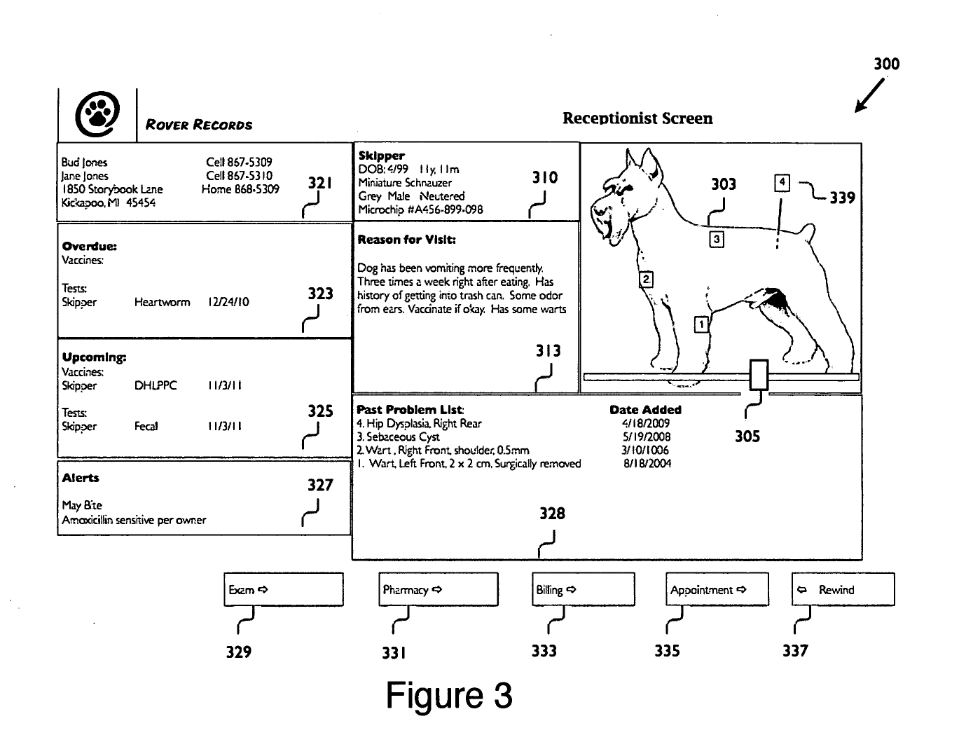

FIG. 2 is one embodiment of a more detailed block diagram of the patient module. The patient module 103 comprises a user interface engine, a data storage 205, a three-dimensional generating engine 207, a diagnosing engine 211, a communication module 213 and a form completion engine 217. The user interface engine 202 is coupled to the bus via signal line 222. The user interface engine 202 generates a user interface and receives user input. The user interface displays a three-dimensional model of a patient and various areas for inputting patient information. FIGS. 3-9, as discussed below, are examples of user interfaces that display a three-dimensional model. In one embodiment, the user interface engine 202 transmits any information received via the user interface in data storage 205, which is coupled to the bus via signal line 223.

The three-dimensional generating engine 207 generates three-dimensional models of the patient. The models include a full-body display, all the organs, etc. The model can be rotated, for example by clicking an area on the user interface once and dragging the area in a particular direction. The user can implement these modifications via a stylus, using a Bluetooth keyboard, a finger, etc. In another embodiment, the three-dimensional generating engine 207 also displays cross-sectional layers of the patient, such as the tissues, the skeletal system, the muscular system, the circulatory system, the nervous system, etc. The user can then access a specific layer by clicking on it. The models are not necessarily generated by imagines created using patient's data. The models can be from a generic display with similar characteristics of the body or organs in questions.

The three-dimensional model provides the doctor with a tool for recording very precise details. For example, a bird comes in with a scratched cornea. The doctor selects a model of the eye and marks the exact dimensions of the scratch. In one embodiment, the doctor even takes a picture of the scratch and the user interface provides a mechanism for associating the picture of the scratch with the model of the eye. This way the doctor has a record of the extent of the damage and can measure the bird's progress.

In another example, a dermatologist uses the three-dimensional model for keeping track of a patient's moles. The user interface displays a picture of the patient's back and the doctor marks where the patient has moles. This way, when the patient comes in for yearly checkups, the dermatologist can quickly identify whether a new mole has appeared. Furthermore, if a mole is slightly irregular but does not warrant a biopsy, the dermatologist uses the three-dimensional model to monitor the mole to see whether, in the intervening time period, the mole became more irregular.

In one embodiment, the user interface engine 202 displays the three-dimensional model in conjunction with a sliding scale. This allows the user to make adjustments in the size of the person. For example, when a doctor meets a patient for the first time he can select a full-body model of the patient and use the sliding scale to represent the patient as anything from underweight to morbidly obese. This can be especially helpful when interacting with a patient or the patient's owner. For example, an owner has a dog that is a bit overweight, but she does not want to characterize the dog as overweight. By showing the owner a picture of the dog, the doctor can avoid quibbling with terminology by simply pointing to the picture.

The diagnosing engine 211 is coupled to the bus via signal line 225. In one embodiment, the user enters information about a particular organ via the user interface and the diagnosing engine 211 uses the information to suggest possible maladies. This is more useful than conventional systems because it quickly narrows the problems down to specific organs. In addition, when multiple organs are implicated, the diagnosing engine 211 can more quickly identify the problem as compared to manually looking up the illnesses associated with each organ and then comparing the illnesses.

The communication engine 213 is coupled to the bus via signal line 227. The communication engine communicates with other medical applications to transmit instructions. In one embodiment, the communication engine 213 transmits the information to medical software/applications 109 stored on the medical server 101. For example, the diagnosing engine 211 determines that the patient needs an antibiotic so the communication module 213 transmits the prescription to the patient's local pharmacy.

In another embodiment, the communication module 213 works with the form completion engine 217, which is coupled to the bus via signal line 226 to transmit completed forms to other medical applications. For example, the form completion engine 217 generates a list of the different tests to be performed on the patient and instructions for the patient that detail how and where to take the tests, such as fasting before a cholesterol test and visiting the blood-drawing station at 105 Main St. when it's time to have the blood drawn.

FIG. 3 is a user interface 300 of the general information screen for inputting patient information. The user interface displays a picture 303 of the patient. In this example the patient is a dog but persons of ordinary skill in the art will recognize that the patient could easily be a human. The user (doctor, nurse, technician, etc.) inputs a body condition score (BCS). In this example, the BCS is marked by manipulating a slider 305. The patient's name, breed, gender and other identifying characterstics are included in the patient identification box 310. The Reason for the Visit is noted in box 313, which includes information about the patient's history and current complaints. Options are available to the user such as initiating a physical exam in box 329, prescribe medication with box 331, see current billing information via box 333, schedule an appointment with box 335, and move back to a previous screen with box 337.

From the general information screen in FIG. 3, the user can view the past problem list that is summarized in box 328. Box 321 includes the owner's history (in the case of an animal patient), or in the case of a human, this box 321 could contain the Parent's or Responsible Party's name, address, and phone numbers. Box 323 includes a summary of Overdue tests or treatments. Box 325 lists Upcoming tests or treatments. Box 327 includes Alerts such as allergic reactions or drug sensitivities.

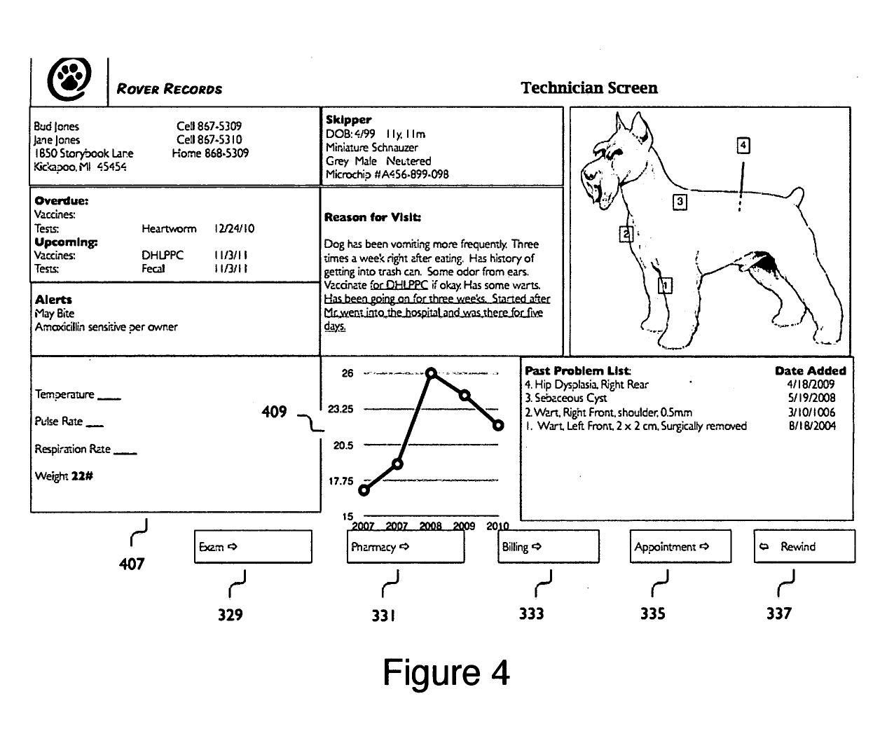

FIG. 4 is a user interface 407 in which the patient's temperature, pulse rate, respiration rate and weight are input. The weight is displayed graphically in box 409.

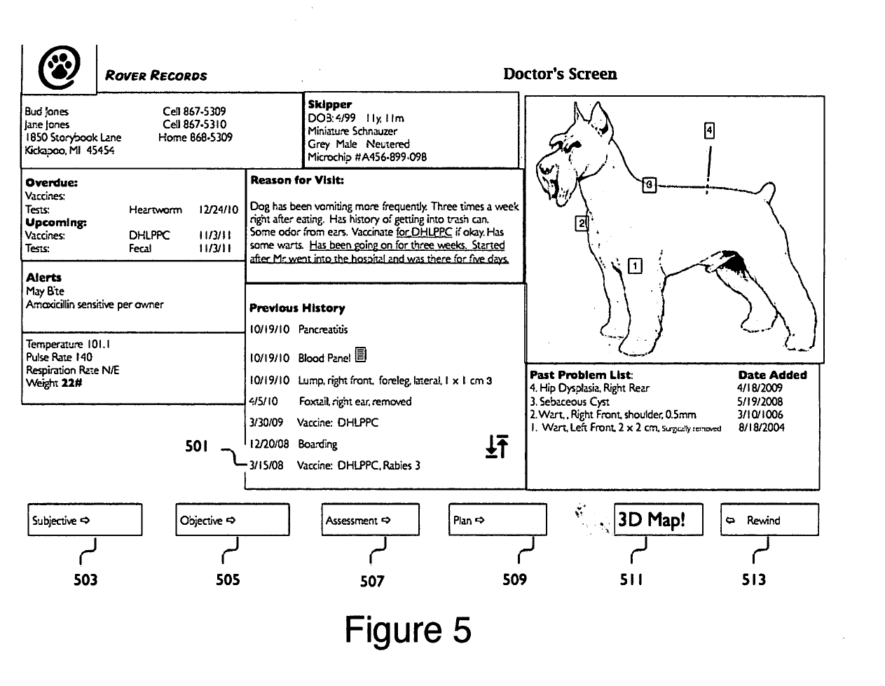

FIG. 5 is a user interface in box 501 that displays the previous history of the patient, with the ability to access scanned blood work, radiographic images and other reports. The doctor begins an examination of the patient by selecting subjective box 503 by examining each organ selects the objective box 505, the assessment box 507 or the plan box 509 to input additional information. Selecting the objective box 505 presents the user with boxes for inputting characteristics of different organs. Selecting the assessment box 507 presents the user with suggested diagnoses. Selecting the plan box 509 presents the user with a plan for medical treatment, such as a list of prescriptions, etc. Box 511 brings the 3-dimensional representation of the patient to full screen, allowing the user to precisely mark any pathology. Box 513 allows the user to return to a previous screen.

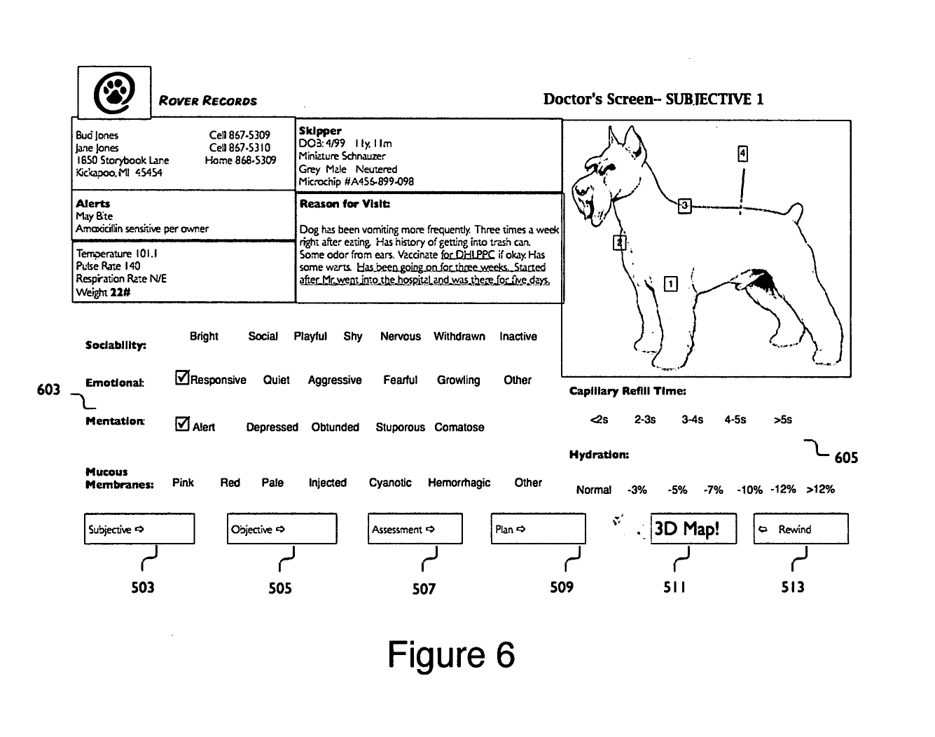

FIG. 6 is a user interface for inputting in box 603, in the case of an animal patient, the animal's sociability, emotional status, mentation, and mucous membrane color. Box 605 is designated for user input of capillary refill time and hydration.

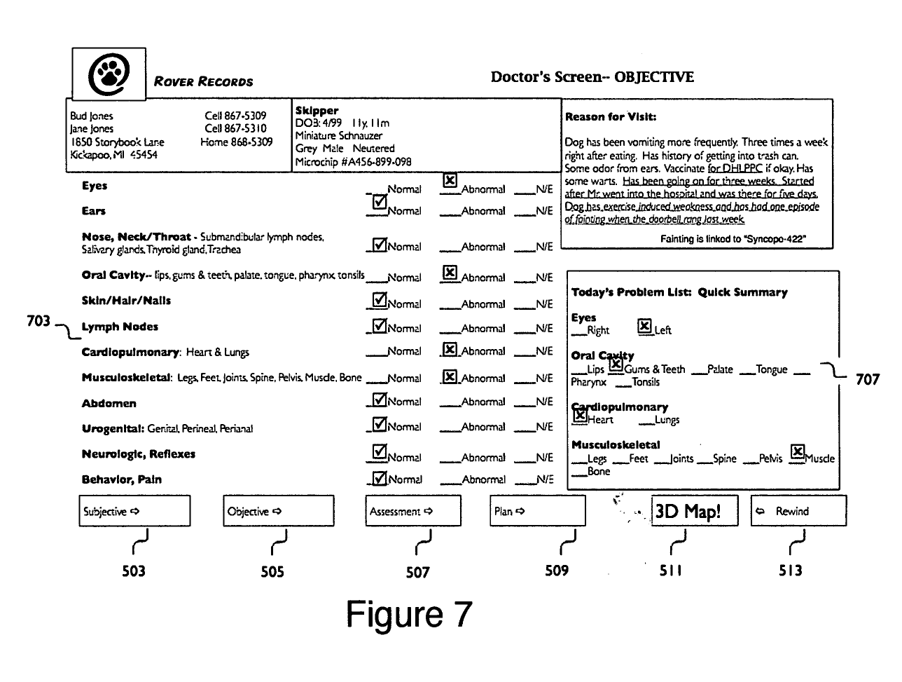

FIG. 7 is a user interface 703 that displays the different organs for inputting patient information. In this example, the user interface displays selectable boxes for the various organs or organ-systems listed. A quick summary of the abnormal organs or organ-systems is present in box 707.

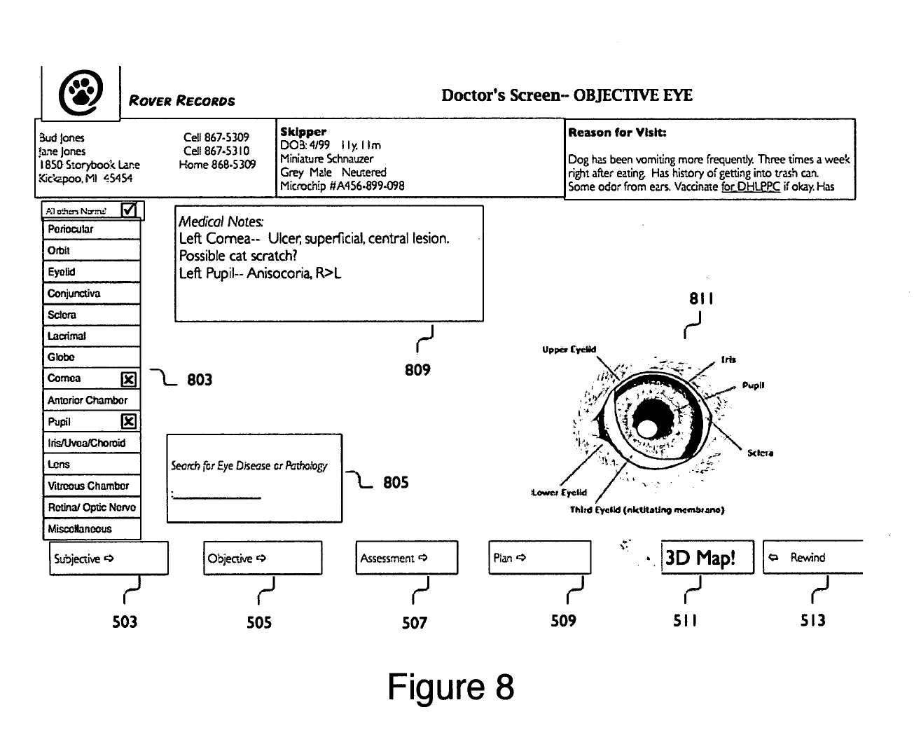

The user selects the eyes box 703 or box 707 to display information associated with the eye. FIG. 8 is a user interface 803 and graphic 811 that is displayed responsive to selecting the eyes in box 703 or box 707. The user interface includes a picture of the abnormal left eye graphic 811 that is listed in box 703 and box 707. Box 809 allows the user to type in objective observations. Graphic 811 allows the user to note those abnormalities precisely by drawing on a graphical representation of the organ, in this case the left eye. Box 805 allows the user to search for a specific eye disease or pathology in the system's database. A box similar to 805 is present for all other abnormal organs or organ-systems throughout the objective component of the exam. In this example the left eye is abnormal with a superficial corneal ulcer and aniscoria of the left pupil.

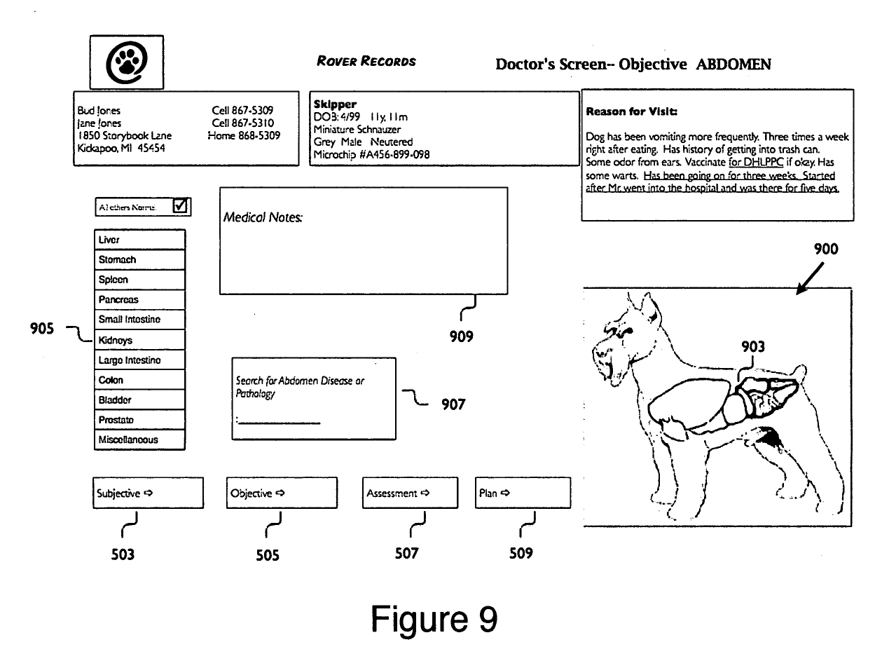

As the doctor proceeds through the examination, it is helpful to keep track of the different organs to be examined. FIG. 9 is a user interface 905 for inputting an objective 505 of different internal organs that displays both a visual of the different organs in box 903 and a list of the different organs in box 905. The user interface 909 displays information associated with a particular organ in response to selecting a picture of the organ or a box listing the organ FIG. 9 is a user interface 900 that includes a visual display of the different organs and indicates which organs have already been studied. In this example, the drawing of the heart 903 is gray to indicate that the heart examination is complete.

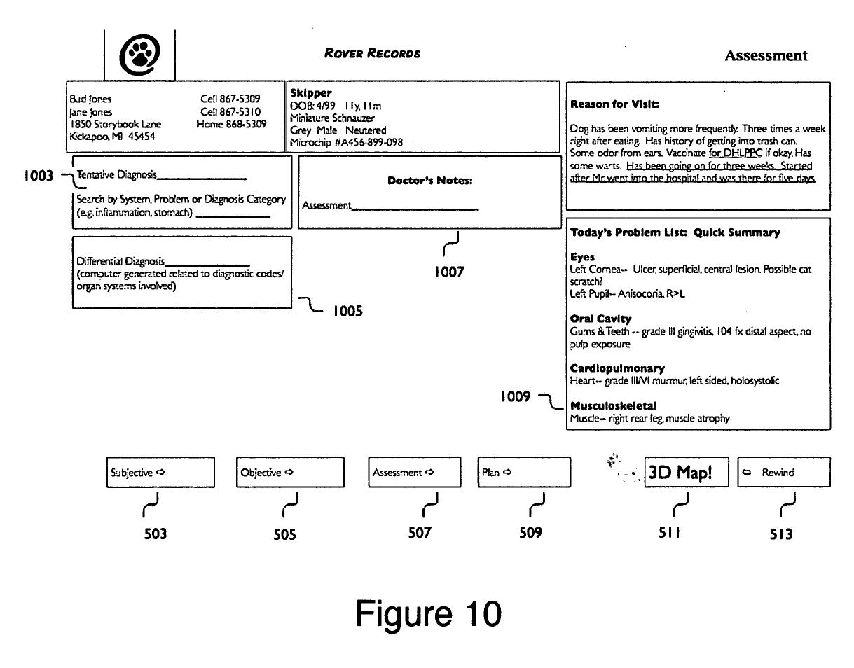

The user selects the assessment box 507 when the objective component of the exam is completed. FIG. 10 is a user interface for the user to input the tentative diagnosis in box 1003, the differential diagnosis in box 1005, make an assessment of the patient on box 2007. A quick summary of the completed subjective and objective components of the physical exam are represented in box 1009.

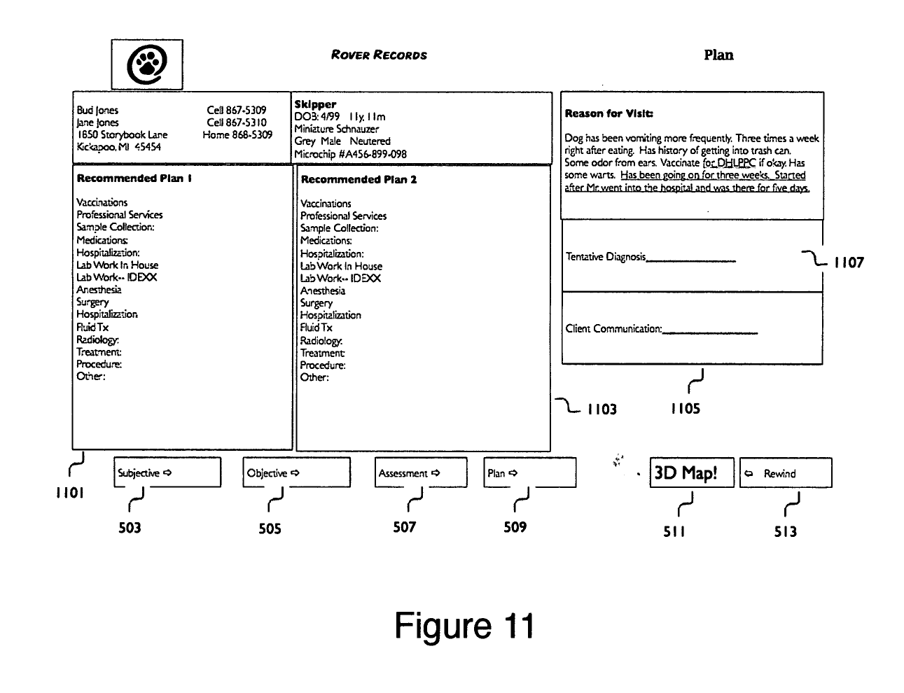

Once the user is done with the assessment, the plan is selected in box 509. In FIG. 11, the option for two treatment or diagnostic plans are available in box 1101 and box 1103. The tentative diagnosis is listed in box 1107, and any necessary client communication is noted in box 1105.

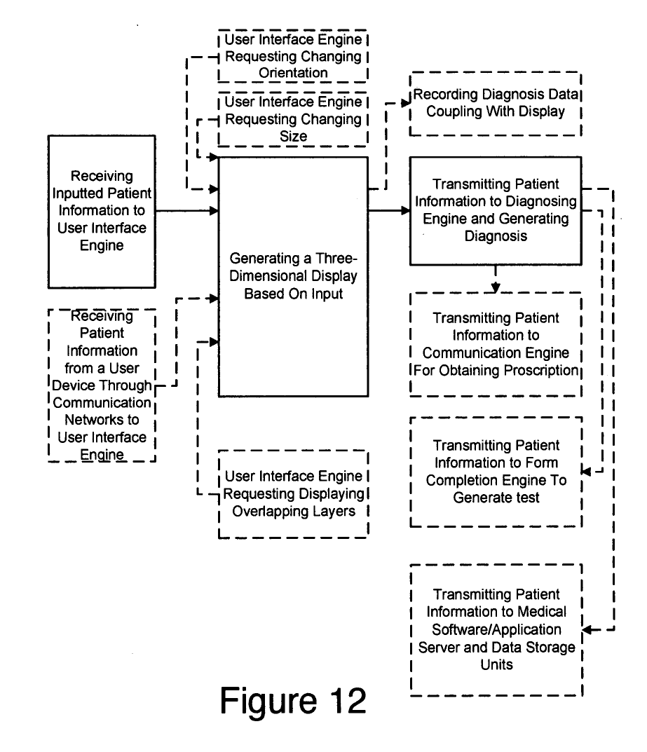

FIG. 12 shows an embodiment of the process flow of the invention. The user interface engine receives patient information, and the information is used to generate a three-dimensional display by a three-dimensional engine. The information can then transmit to a diagnosing engine that generates report and diagnosis.

In one embodiment, a user device of any client computing device sends in patient information, such as a personal computer and a mobile device (a mobile phone, an iPad or any other device that accepts user input to complete electronic forms). The user device can input information from a communication network discussed above.

In another embodiment, the user interface engine can request changing patient's orientation and the three dimensional engine will respond by changing the orientation as required. Also, the user interface engine can request changing the size of the display of the patient based on user input.

The three-dimensional engine generates overlapping layers of patient's organs in one embodiment. A doctor may discuss with the patient or patient's owner when a pet is the patient about all the organs involved in the diagnosis.

Optionally patient data can be tagged to a three dimensional display so a doctor can use the data for diagnosis or show the patient related historical data in current or future diagnosis.

In one embodiment, the resulting information from diagnosing engine is sent through communication engine, and the information can be used to send to local pharmacy to get proscription or help patient to get further diagnosis.

In yet another embodiment, the resulting information from diagnosing engine is sent over to a form completion engine that generates the prescription forms, bills, etc.

In addition, in another embodiment, the resulting information from diagnosing engine may also be sent to a medical software and application server and a data storage unit so that the medical software and application server may provide comprehensive medical services and save patient's medical records there for further diagnosis.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats. Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

What is claimed is:

1. An apparatus for generating a three-dimensional user interface of patient information comprising:
a user interface engine for receiving user input;
a three-dimensional generating engine coupled to said user interface engine, said three-dimensional generating engine for generating a three-dimensional display that is displayed on said user interface; and
a diagnosing engine that is coupled to said user interface engine, said diagnosing engine receiving the patient information and generating a diagnosis.

2. The apparatus of claim 1 wherein said user interface engine representing a patient using a sliding scale.

3. The apparatus of claim 1 wherein said user interface engine receiving user input where a user device transmitting the input that said user device received through at least one communication network.

4. The apparatus of claim 1 wherein the three-dimensional display being displayed on a user interface of a user device transmitting and receiving patient information through at least one communication network.

5. The apparatus of claim 1 wherein said three-dimensional generating engine causing the display to change size based on input from said user interface engine.

6. The apparatus of claim 1 wherein said three-dimensional generating engine causing the display to change orientation based on input from said user interface engine.

7. The apparatus of claim 1 wherein said three-dimensional generating engine displaying plurality of layers of overlapping organs of a patient based on input from said user interface engine.

8. The apparatus of claim 1 wherein said three-dimensional generating engine recording data tagging along the display based on input from said user interface engine whereby the data can be referred to in the current and future diagnosis.

9. The apparatus of claim 1 further including a communication engine transmitting information generated by said diagnosing engine to outside of said apparatus whereby the information can be used to facilitate patient obtaining proscription.

10. The apparatus of claim 1 further including a communication engine transmitting information generated by a form completion engine that generates a predetermined number of tests whereby the information can be used for further diagnosis.

11. The apparatus of claim 1 further coupling with a medical software and application server and a data storage unit whereby said medical software and application server providing predetermined medical services and said data storage contains patients' medical records.

12. A method of diagnosing patient using at least one programmable electronic data processing machine comprising:
Receiving inputted patient information to a user interface engine of said machine;
Generating a three-dimensional display using the patient information on the user interface through a three-dimensional engine coupled to said user interface engine; and
Transmitting the patent information to a diagnosing engine coupled to said user interface engine and generating a diagnosis.

13. The method of claim 12 wherein said user interface engine receiving user input where a user device transmits the input that said user device received through at least one communication network.

14. The method of claim 12 wherein said three-dimensional generating engine causing the display to change size based on input from said user interface engine.

15. The method of claim 12 wherein said three-dimensional generating engine causing the display to change orientation based on input from said user interface engine.

16. The method of claim 12 wherein said three-dimensional generating engine displaying plurality of layers of overlapping organs of a patient based on input from said user interface engine.

17. The method of claim 12 wherein said three-dimensional generating engine recording data tagging along the display based on input from said user interface engine whereby the data can be referred to in the current and future diagnosis.

18. The method of claim 12, further including transmitting information generated by said diagnosing engine through a communication engine whereby the information can be used to facilitate patient obtaining proscription.

19. The method of claim 12, further including transmitting pre-determined number of test generated by a form completion engine through a communication engine whereby the information can be used for further diagnosis.

20. The method of claim 12, further including transmitting information generated by said diagnosing engine to a medical software and application server and a data storage unit whereby said medical software and application server provides predetermined medical services and said data storage contains patients' medical records.
